(19) United States
(12) Patent Application Publication
(10) Pub. No.: US 2018/0365571 A1
(43) Pub. Date: Dec. 20, 2018

(54) Dynamic Converging Times for Real-Time Data Monitoring

(71) Applicant: Microsoft Technology Licensing, LLC, Redmond, WA (US)

(72) Inventors: Suying RUI, Beijing (CN); Chao HE, Beijing (CN); Junfeng ZHANG, Beijing (CN); Guodong XING, Beijing (CN)

(73) Assignee: Microsoft Technology Licensing, LLC, Redmond, WA (US)

(21) Appl. No.: 15/622,378

(22) Filed: Jun. 14, 2017

(51) Int. Cl. G06N 5/04; G06F 17/30; G06N 99/00

(52) U.S. Cl. CPC G06N 5/04; G06N 99/005; G06F 17/30997

(57) ABSTRACT

A real-time data monitoring system includes a converging time-series generation component to analyze historical data of a time-series to determine converging times for data points of the time-series at various times of a day. Each converging time indicates a predicted amount of time for the respective data point of the time-series to converge. The converging time-series generation component then generates a converging time-series which pairs the converging times with respective timestamps. A data retrieval component of the real-time data monitoring system is configured to dynamically adjust a retrieval time for data points of the time-series based on the converging times of the converging time-series, and retrieve each data point of the time-series at the determined retrieval time from one or more data sources. The real-time data monitoring system processes the retrieved data points of the time-series to generate one or more real-time alerts.

### BACKGROUND

Conventional real-time data monitoring systems are configured to process time-series data with a long latency and varied converging times. For example, a real-time data monitoring system configured for anomaly detection may leverage a machine learning model for real-time data monitoring and generate an alert when an anomaly is detected. Consider, for example, a time-series which includes a data point and a timestamp for each data point (e.g., data point, timestamp). Ideally, for real-time data monitoring, each data point in the time-series could be used immediately after its corresponding timestamp. For example, for a data point (x, 13:05), the real-time data monitoring system would like to retrieve and process the data point right after it is generated at 13:05. Unfortunately, most data points have a latency which affects when the data point is fully converged and ready for monitoring. Such latency may be caused by a variety of different factors, such as data collection processing time, data source population latency, and so forth.

### SUMMARY

Dynamic converging times for real-time data monitoring techniques are described herein. In one or more implementations, a real-time data monitoring system includes a converging time-series generation component to analyze historical data of a time-series to determine converging times for data points of the time-series at various times of a day. Each converging time indicates a predicted amount of time for the respective data point of the time-series to converge. The converging time-series generation component then generates a converging time-series which pairs the converging times with respective timestamps. A data retrieval component of the real-time data monitoring system is configured to dynamically adjust a retrieval time for data points of the time-series based on the converging times of the converging time-series, and retrieve each data point of the time-series at the determined retrieval time from one or more data sources. The real-time data monitoring system processes the retrieved data points of the time-series to generate one or more real-time alerts.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The same numbers are used throughout the drawings to reference like features and components.

FIG. 1 is an illustration of an environment in an example implementation that is operable to support techniques described herein.

FIG. 2 illustrates a system in an example implementation in which operation of the real-time data monitoring system of FIG. 1 is shown in greater detail in accordance with one or more implementations.

FIG. 3 illustrates an example converging time graph mapping convergence percentage to time for a single data point of a time-series.

FIG. 4 illustrates an additional example converging time graph mapping two different converging percentages to time for a single data point of a time-series.

FIG. 5 illustrates an example method 500 of processing data points of a time-series using in accordance with one or more implementations.

FIG. 6 illustrates an example system that includes an example computing device that is representative of one or more computing systems and/or devices that may implement the various techniques described herein.

### DETAILED DESCRIPTION

Different data points of a time-series may have different converging times which vary over the course of a day. As described herein, the “converging time” corresponds to an amount of time for a data point to converge. In a real-time data monitoring system, “un-converged” data may not be qualified for monitoring. For example, some machine learning models such as holt-winter require data points of time-series to be close to fully converged when retrieved for processing.

Thus, in a real-time data monitoring system, there is always a trade-off between accuracy and monitoring data in real-time. Some conventional data monitoring systems simply tolerate a fixed converging time that is long enough to ensure all data points will be fully converged when retrieved and processed. For example, a long converging time of 35 minutes can be chosen to ensure that all data points are fully converged. In this case, a data point with a timestamp of 13:05 will be retrieved and processed at a time of 13:40. Notably, using a long converging time virtually guarantees that the data point will be fully converged when it is retrieved and processed thereby increasing the accuracy of the data monitoring system. The drawback of using a long converging time, however, is that the system is not truly “real-time” because in some cases the data may be retrieved and processed long after the data is generated.

Other conventional data monitoring systems utilize a more “aggressive” fixed converging time that is designed to retrieve and process data in real-time, while sacrificing monitoring accuracy for some data points. For example, a shorter converging time of 20 minutes can be chosen as a tradeoff between monitoring accuracy and real-time data retrieval. In this case, consider that from 0:00 to 12:00, the converging time is 15 minutes, from 12:00 to 18:00 the converging time is 5 minutes, and from 18:00 to 24:00 the converging time is 35 minutes. The fixed converging time of 20 minutes, in this example, ensures that the retrieved data is fully converged in some cases (e.g., from 0:00 to 12:00 and from 12:00 to 18:00), but only partially converged in other cases (e.g., from 18:00 to 24:00). Thus, using a shorter converging time improves real-time data retrieval but monitoring accuracy suffers for at least some data points. Further, in many cases a shorter converging time could have been used for at least some of the data points. In the example above a converging time of 20 minutes is much longer than needed during the time period from 12:00 to 18:00 where the converging time is just 5 minutes.

Dynamic converging times for real-time data monitoring techniques are described herein. In one or more implementations, a real-time data monitoring system includes a converging time-series generation component to analyze historical data of a time-series to determine converging times for data points of the time-series at various times of a day. Each converging time indicates a predicted amount of time for the respective data point of the time-series to converge (e.g., to become fully converge or to become converged to an acceptable percentage such that it is ready to be processed). The converging time-series generation component then generates a converging time-series which pairs the converging times with respective timestamps identifying a time of day.

A data retrieval component of the real-time data monitoring system is configured to dynamically adjust a retrieval time for data points of the time-series based on the converging times of the converging time-series, and retrieve each data point of the time-series at the determined retrieval time from one or more data sources. The real-time data monitoring system processes the retrieved data points of the time-series to generate one or more real-time alerts.

Notably, adjusting the retrieval time of data points of the time-series based on dynamic converging times improves the accuracy of the real-time data monitoring system by ensuring that the retrieved data points of the time-series are fully converged, or converged to an acceptable percentage. In addition, unlike conventional systems which utilize fixed retrieval times, the data monitoring system retrieves the data points of the time-series in an aggressive real-time mode by retrieving and processing the data as soon as possible based on the predicted converging times of the converging time-series.

Example Environment

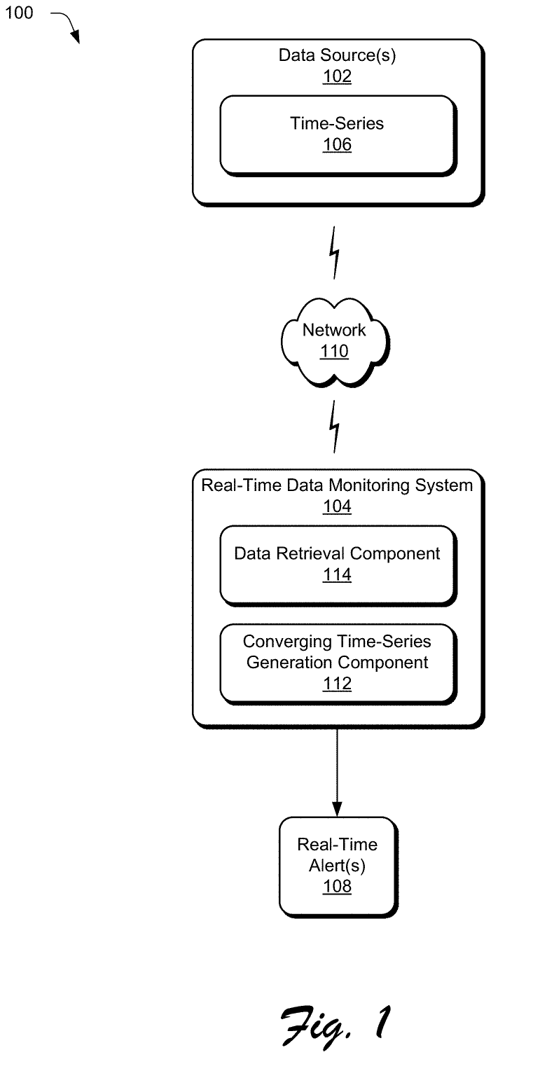

FIG. 1 is an illustration of an environment 100 in an example implementation that is operable to support techniques described herein. The illustrated environment 100 includes data sources 102 which are monitored by a real-time data monitoring system 104. The real-time data monitoring system 104 receives time-series 106 from the data sources 102. As described herein, time-series 106 corresponds to a series of data points which are indexed or listed in time order. In some cases the data points of the me-series 106 are taken at successive equally spaced points in time.

The real-time data monitoring system 104 processes the time-series 106 in order to generate one or more real-time alerts 108. Real-time alerts 108, for example, may be output by real-time data monitoring system 104 in response to detection of an anomaly in the time-series 106. Notably, the real-time data monitoring system 104 is configured to generate the real-time alerts 108 substantially in real-time, with minimal delay between the generation of the time-series and the output of real-time alerts 108.

Real-time data monitoring system 104 may be configured to monitor a variety of different types of time-series 106. In one or more implementations, the time-series 106 is associated with a communication system. In this case, the time-series 106 may include data points which correspond to various communication events, such as establishing a communication session, communicating text messages, placing voice calls, and so forth. In this example, the time-series 106 can be processed to identify various anomalies or errors, which may be indicative of a problem on the server or at one or more client devices. Notably, real-time data monitoring system may be configured to monitor any type of time-series 106.

Data sources 102 may be implemented in a variety of different ways. In one or more implementations, data sources 102 correspond to a telemetry system that monitors individual devices and or services in order to generate the time-series 106. Telemetry is an automated communications process by which measurements and other data are collected at remote or accessible points and transmitted to receiving equipment for monitoring. For example, a telemetry system may be configured to monitor communication devices (e.g., smartphones, desktop computing devices, laptops, tablets) that are running a communication application over a network, such as a voice-over-IP communication application, a text messaging application, and so forth. Alternately, in one or more implementations, the data sources 102 may correspond to the individual devices.

Data sources 102 and real-time data monitoring system 104 are communicatively coupled, one to another, via a network 110. Computing devices that implement the data sources 102 and real-time data monitoring system 104 may be configured in a variety of different ways.

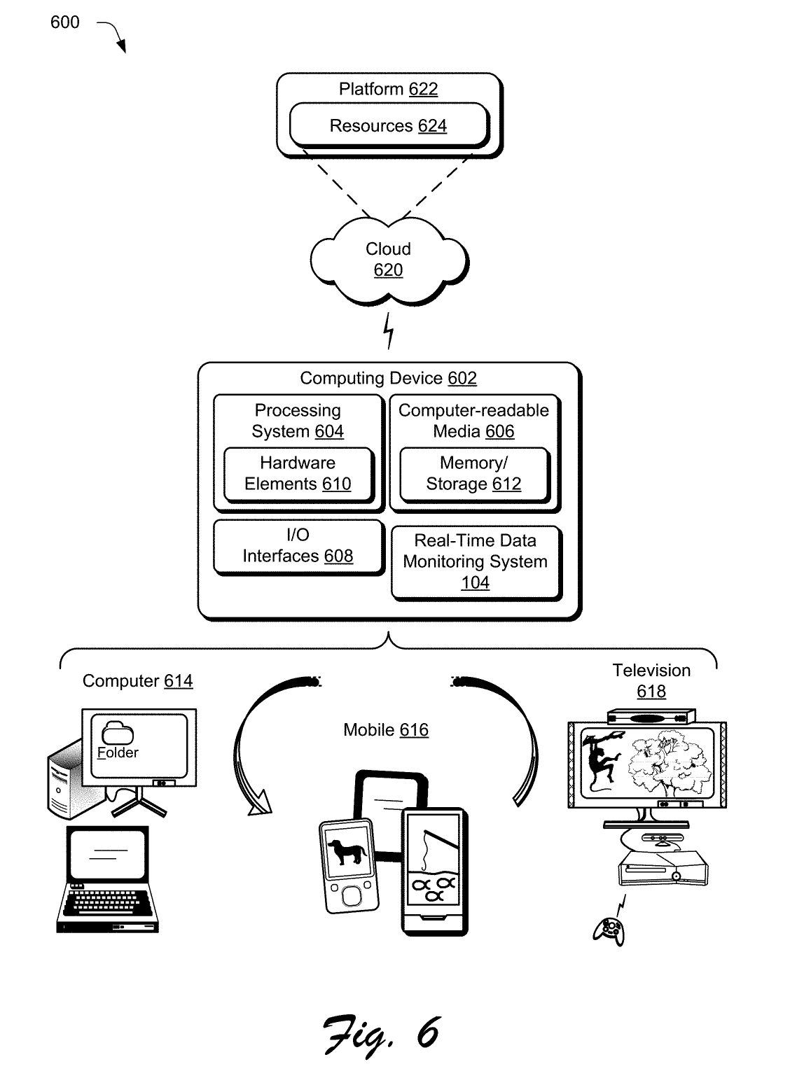

A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is described in some instances, the computing device may be representative of a plurality of different devices, such as multiple servers utilized by a business to perform operations “over the cloud” for the real-time data monitoring system 104, further discussion of which may be found in relation to FIG. 6.

Although network 110 is illustrated as the Internet, the network may assume a wide variety of configurations. For example, network 110 may include a wide area network (WAN), a local area network (LAN), a wireless network, a public telephone network, an intranet, and so on. Further, although a single network 110 is shown, network 110 may also be configured to include multiple networks.

The real-time data monitoring system 104 is illustrated as including a converging time-series generation component 112 and a data retrieval component 114. The converging time-series generation component 112 is representative of functionality to analyze historical data of the time-series 106 to determine converging times for data points of the time-series 106 at various times of a day, and to generate a converging time-series that pairs the converging times with respective timestamps. As discussed throughout, each converging time indicates a predicted amount of time for the respective data point of the time-series 106 to converge (e.g., to become fully converged or to become converged to an acceptable percentage such that it is ready to be processed).

The data retrieval component 114 is representative of functionality to dynamically adjust a retrieval time for data points of the time-series 106 based on the converging times of the converging time-series, and to retrieve each data point of the time-series 106 at the determined retrieval time from data sources 102. The real-time data monitoring system 104 can then process the retrieved data points of the time-series 106 to generate the real-time alerts 108.

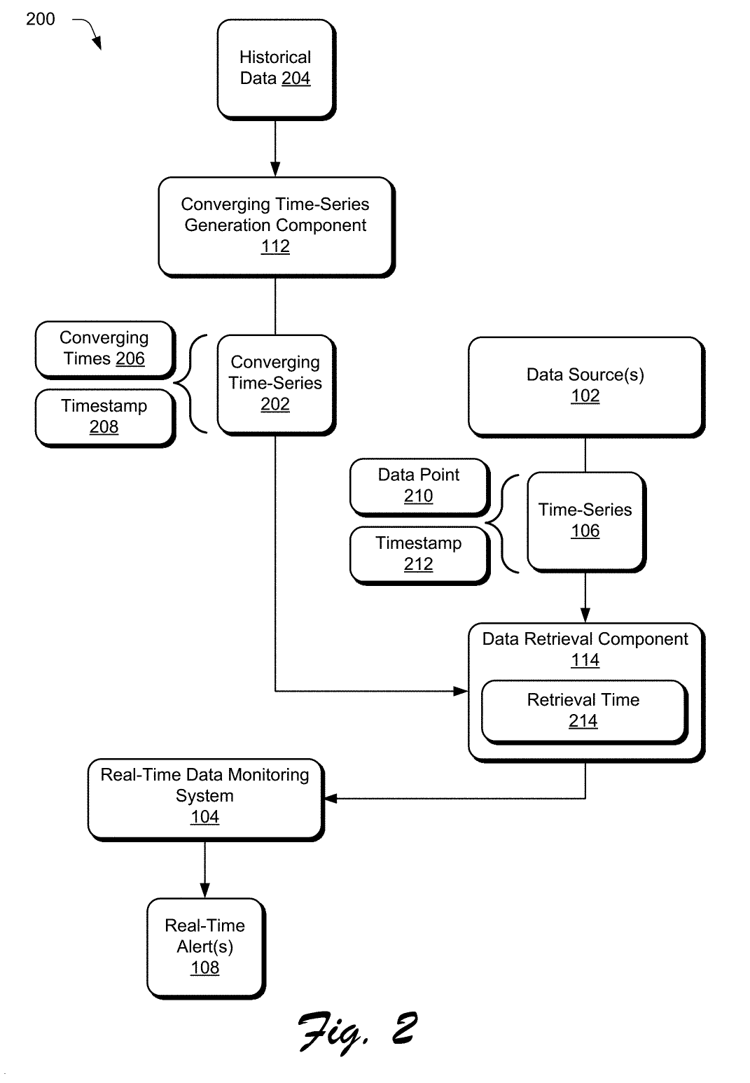

FIG. 2 illustrates a system 200 in an example implementation in which operation of the real-time data monitoring system 104 of FIG. 1 is shown in greater detail in accordance with one or more implementations.

In system 200, in a training mode, converging time-series generation component 112 generates a converging time-series 202 based on historical data 204 of the time-series 106. To do so, the converging-time-series generation component 112 analyzes the historical data to determine converging times 206 for data points of the time-series 106 at various times of day. For example, throughout the course of the day, the converging times 206 for data points of the time-series 106 may vary based on a variety of different factors, such as network conditions, the number of users using a service or device, different use patterns, data collection processing times, and so forth. Thus, by analyzing the historical data 204 of the time-series 106, the converging-time-series generation component 112 can recognize patterns in the time-series data in order to generate the converging times 206 which predict the amount of time for the data to converge at different times of day. The different times of day may be spaced in accordance with the sequence of the time-series data, such as every minute or every 5 minutes. In many cases different converging times 206 can be determined for the time-series 106 based on geographical location.

Converging time-series generation component 112 generates the converging time-series 202 by pairing the converging times 206 with respective timestamps 208. In some cases the timestamps identify a time of day using a 24-hour clock, while in other cases the timestamps may identify the time of day using a 12-hour clock. Thus, the converging time-series 202 may be represented in the format (converging time, timestamp). The timestamps correspond to times of day which are spaced based on the sequence of the time-series 106.

In effect, the converging time-series 202 is a property of the time-series 106 because each converging time 206 is paired with a timestamp that maps to a respective timestamp of the time-series 106. For example, at a timestamp 208 of 13:00 the converging time 206 for a data point of the time-series 106 may be 15 minutes, while at 13:30 the converging time 206 for a data point of the time-series 106 may be just 5 minutes. Thus, the converging times of the time-series is dynamic, such that the converging times change for different data points instead of being fixed like conventional solutions.

In some cases, the converging time 206 may correspond to a predicted amount of time for the data point of the time-series 106 become “fully converged” (e.g., converged to 100%). Alternately, the converging time 206 may correspond to a predicted amount of time for the data point of the time-series 106 to become converged to an acceptable convergence percentage. For example, in some cases the real-time data monitoring system 104 may only need the data to be 80% or 90% converged. The acceptable convergence percentage may be defined or adjusted by a user or administrator of real-time data monitoring system 104.

The converging time-series generation component 112 provides the converging time-series 202 to the data retrieval component 114 of real-time data monitoring system 104 to enable the data retrieval component 114 to dynamically adjust the retrieval time for each data point of the time-series 106 in a real-time data retrieval mode. Doing so ensures that the data points of time-series 106 is retrieved at a convergence percentage that is sufficient for data processing, while also being as close to real-time as possible.

In the real-time data retrieval mode, data-retrieval component 114 dynamically adjusts the retrieval time for data points of the time-series 106 based on the converging time-series 202. As illustrated in FIG. 2, the time-series 106 includes data points 210 and respective timestamps 212 corresponding to each data point 210. In order to retrieve a particular data point 210, data-retrieval component 114 calculates a retrieval time 214 for the particular data point 210.

To calculate the retrieval time 214 for a particular data point 210, data-retrieval component 114 determines the respective converging time 206 associated with the data point 210. The converging time 206 is determined by matching the timestamp 212 of the time-series 106 with a respective timestamp 208 of the converging time-series 202. Then, the retrieval time 214 is computed by adding the converging time 206 to the timestamp 212 of the time-series 106.

As an example, consider the following time-series in the format (data point, timestamp): (a,1:00), (b,1:15), and (c,1:30). In addition, consider the following converging time-series, which is mapped to data points a, b, and c of the original time-series, and in the format (converging time, timestamp): (15,1:00), (10,1:15), and (5,1:30). In this example, data retrieval component 114 calculates the retrieval time, for each data point, by adding the converging time to the timestamp. For example, data retrieval component 114 determines the converging time for data point “a” as 1:15 (1:00+15), for data point “b” as 1:25 (1:15+:10), and for data point “c” as 1:35 (1:30+:05).

Next, data retrieval component 114 retrieves each respective data point 210 of the time-series 106 at the calculated retrieval time 214. As such, the delay between generation and retrieval of the data point varies in order to enable each data point to converge Doing so enables the data retrieval component 114 to retrieve data points of time-series 106 which are fully converged, or converged to an acceptable convergence percentage, in an aggressive real-time retrieval mode.

The real-time data monitoring system 104 then processes the retrieved data points of time-series 106 in order to generate one or more real-time alerts 108. Real-time alerts 108, for example, may be output by real-time data monitoring system 104 in response to detection of an anomaly in the time-series 106. Notably, the real-time data monitoring system 104 is configured to generate the real-time alerts 108 substantially in real-time, with minimal delay between the generation of the time-series and the output of real-time alerts 108.

In one or more implementations, real-time data monitoring system 104 leverages a machine learning model in order to process the data points and generate the real-time alerts 108. For example, real-time data monitoring system 104 can apply a machine learning model to the retrieved data points of the time-series 106 in order to detect one or more anomalies. The real-time alerts 108, in this case, correspond to detection of the one or more anomalies. Detection of such anomalies may signal an error or problem in the monitored system. Thus, by decreasing retrieval times and increasing accuracy, the data-retrieval component 114 improves upon conventional real-time data monitoring systems.

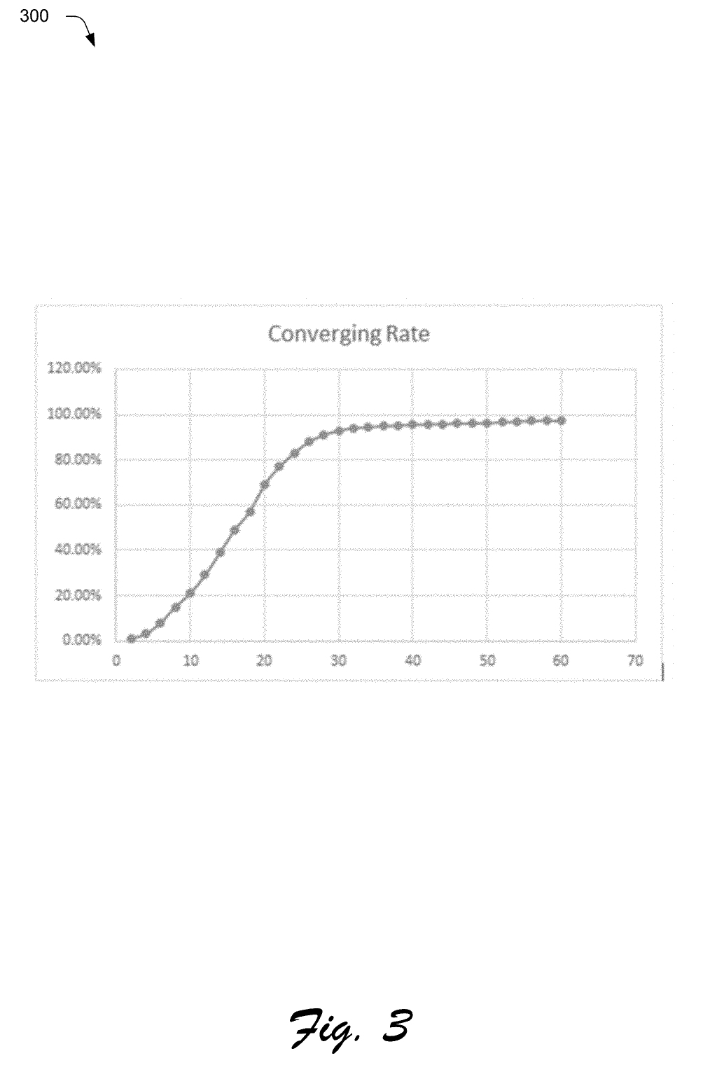

FIG. 3 illustrates an example converging time graph 300 mapping convergence percentage to time for a single data point of a time-series. As shown in FIG. 3, at 10 minutes, the data point is 20% converged, at 20 minutes the data point is approximately 70% converged, and at 60 minutes the data point is fully converged. Thus, an acceptable convergence percentage can be selected by factoring in the requirements of the real-time data monitoring system 104 as well as the need for real-time monitoring. For example, in cases where real-time monitoring is of utmost importance, and a low convergence percentage is acceptable, the convergence percentage of 70% could be selected. Alternately, in cases where the data must be close to fully converged, and real-time alerts is of less importance, a higher convergence percentage could be selected (e.g., 90% to 100%).

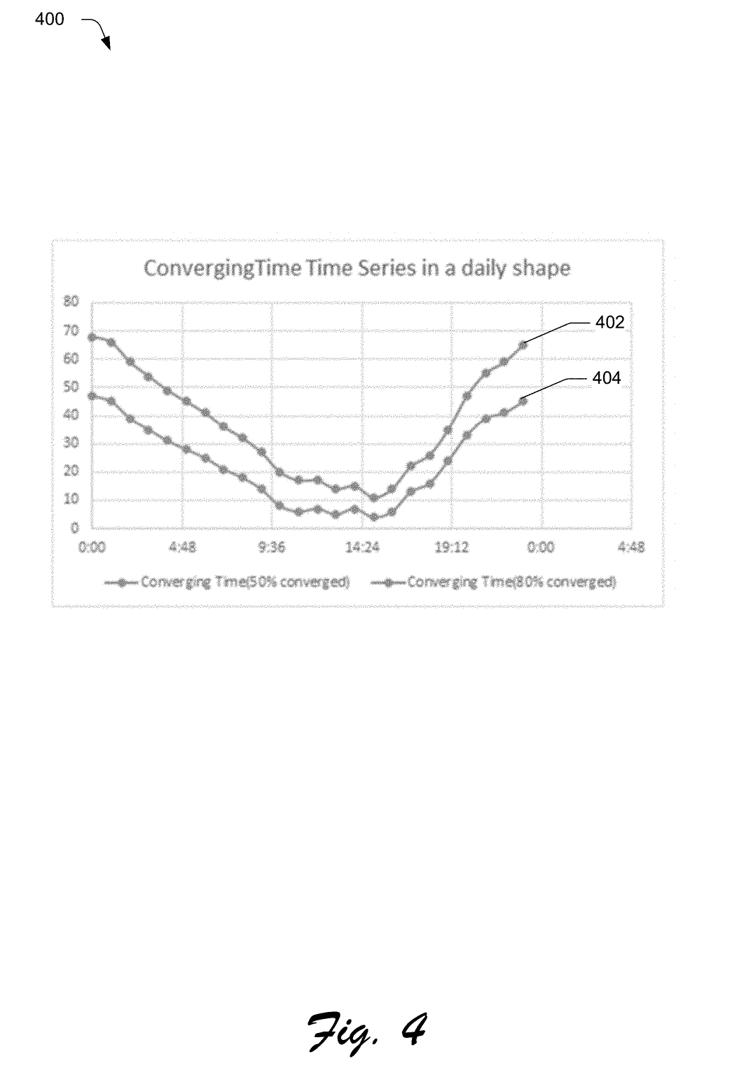

Notably, the converging time-series 202 enables the real-time data monitoring system 104 to select a consistent convergence percentage for all data points of the time-series 106. Consider, for example, FIG. 4 which illustrates an additional example converging time graph 400 mapping two different converging percentages to time for a single data point of a time-series. In this example, at first convergence percentage trend line 402 is shown for a convergence percentage of 80%, and a second convergence percentage trend line 404 is shown for a convergence percentage of 50%. Graph 400 visually illustrates the tradeoff in acceptable converging times for the percentage of convergence. As an example, at a time of 4:48, the converging time for 50% convergence is approximately 30 minutes, whereas the converging time for 80% convergence is approximately 45 minutes. The real-time data monitoring system can use the converging time-series data in order to retrieve data points of the time-series 106 with a fixed convergence percentage.

Example Methods

The methods described herein are shown as sets of blocks that specify operations performed but are not necessarily limited to the order or combinations shown for performing the operations by the respective blocks. The techniques are not limited to performance by one entity or multiple entities operating on one device.

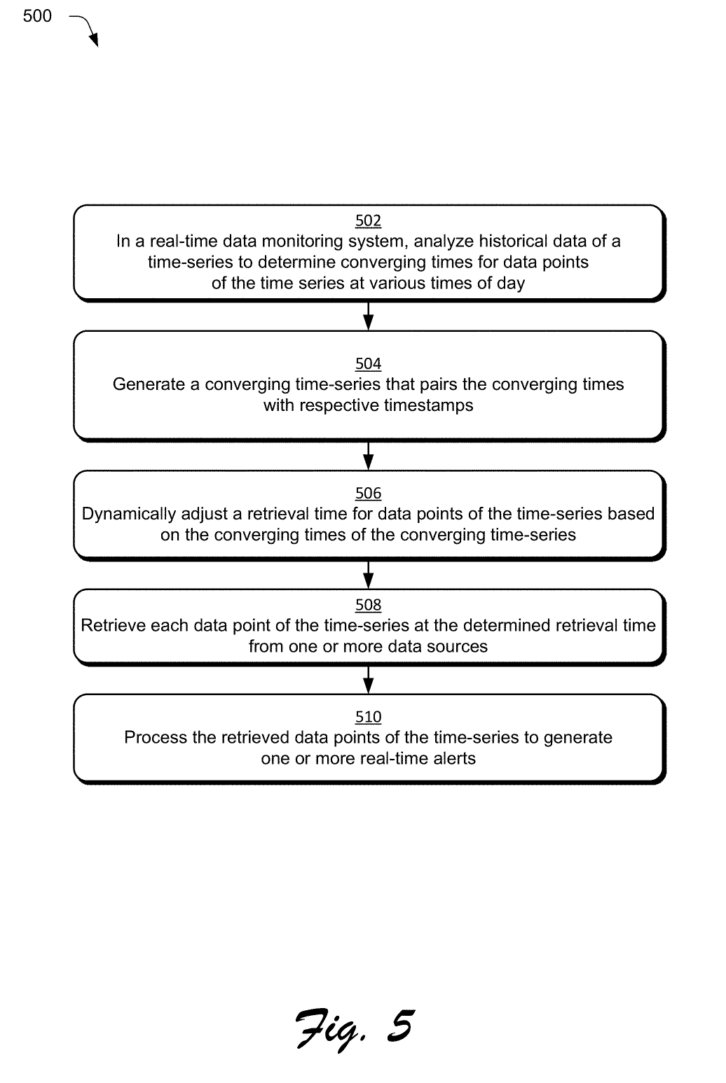

FIG. 5 illustrates an example method 500 of processing data points of a time-series using in accordance with one or more implementations.

At 502, in a real-time data monitoring system, historical data of a time-series is analyzed to determine converging times for data points of the time-series at various times of day. For example, converging time-series generation component 112 analyzes historical data 204 of time-series 106 to determine converging times 206 for data points of the time-series 106 at various times of day. Each converging time indicates a predicted amount of time for the respective data point of the time-series to converge.

At 504, a converging time-series that pairs the converging times with respective timestamps is generated. For example, converging time-series generation component 112 generates a converging time-series 202 which pairs converging times 206 with respective timestamps 208.

At 506, a retrieval time for data points of the time-series is dynamically adjusted based on the converging times of the converging time-series. For example, data retrieval component 114 dynamically adjusts a retrieval time 214 for data points of the time-series 106 based on the converging times 206 of the converging time-series 202.

At 508, each data point of the time-series is retrieved at the determined retrieval time from one or more data sources. For example, data retrieval component 114 retrieves each data point of the time-series 106 at the determined retrieval time 214 from one or more data sources 102.

At 510, the retrieved data points of the time-series are processed to generate one or more real-time alerts. For example, real-time data monitoring system 104 processes the retrieved data points of the time-series 106 to generate one or more real-time alerts 108.

Example System and Device

FIG. 6 illustrates an example system generally at 600 that includes an example computing device 602 that is representative of one or more computing systems and/or devices that may implement the various techniques described herein. The computing device 602 may be, for example, a server of a service provider, a device associated with the client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to a signal-bearing medium that is configured to transmit instructions to the hardware of the computing device 602, such as via a network. Communication media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including real-time data monitoring system 104, and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This is illustrated through inclusion of the real-time data monitoring system 104 on the computing device 602. The functionality of the real-time data monitoring system 104 and other modules may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### Conclusion and Example Implementations

Example implementations described herein include, but are not limited to, one or any combinations of one or more of the following examples:

In one or more examples, a real-time data monitoring system comprises: a converging time-series generation component configured to: analyze historical data of a time-series to determine converging times for data points of the time-series at various times of a day, each converging time indicating a predicted amount of time for the respective data point of the time-series to converge; and generate a converging time-series that pairs the converging times with respective timestamps; a data retrieval component configured to: dynamically adjust a retrieval time for data points of the time-series based on the converging times of the converging time-series; and retrieve each data point of the time-series at the determined retrieval time from one or more data sources; the real-time data monitoring system configured to process the retrieved data points of the time-series to generate one or more real-time alerts.

An example as described alone or in combination with any of the other examples described above or below, wherein the data retrieval component is further configured to determine a converging time associated with a particular data point by matching a first timestamp associated with the particular data point in the time-series with a second timestamp associated with the converging time in the converging time-series.

An example as described alone or in combination with any of the other examples described above or below, wherein the data retrieval component is further configured to compute the retrieval time by adding the determined converging time to the first timestamp.

An example as described alone or in combination with any of the other examples described above or below, wherein each converging time indicates an amount of time for the respective data point of the time-series to become fully converged.

An example as described alone or in combination with any of the other examples described above or below, wherein each converging time indicates an amount of time for the respective data point of the time-series to become converged to an acceptable convergence percentage.

An example as described alone or in combination with any of the other examples described above or below, wherein the acceptable convergence percentage corresponds to a user-defined percentage.

An example as described alone or in combination with any of the other examples described above or below, wherein the one or more data sources comprise a telemetry system configured to monitor multiple client devices or servers.

An example as described alone or in combination with any of the other examples described above or below, wherein the real-time data monitoring system is configured to apply one or more machine learning models to the retrieved data points of the time-series in order to detect one or more anomalies.

An example as described alone or in combination with any of the other examples described above or below, wherein the one or more real-time alerts correspond to detection of one or more anomalies.

An example as described alone or in combination with any of the other examples described above or below, wherein the time-series is associated with a communication application.

An example as described alone or in combination with any of the other examples described above or below, wherein the converging time-series comprises a property of the time-series.

In one or more examples, a computer-implemented method comprises: in a real-time data monitoring system, analyzing historical data of a time-series to determine converging times for data points of the time-series at various times of a day, each converging time indicating a predicted amount of time for the respective data point of the time-series to converge; generating a converging time-series that pairs the converging times with respective timestamps; dynamically adjusting a retrieval time for data points of the time-series based on the converging times of the converging time-series; retrieving each data point of the time-series at the determined retrieval time from one or more data sources; and processing the retrieved data points of the time-series to generate one or more real-time alerts.

An example as described alone or in combination with any of the other examples described above or below, wherein the analyzing further comprises analyzing the historical data of the time-series to determine a converging time associated with a particular data point by matching a first timestamp associated with the particular data point in the time-series with a second timestamp associated with the converging time in the converging time-series.

An example as described alone or in combination with any of the other examples described above or below, further comprising computing the retrieval time by adding the determined converging time to the first timestamp.

An example as described alone or in combination with any of the other examples described above or below, wherein each converging time indicates an amount of time for the respective data point of the time-series to become fully converged.

An example as described alone or in combination with any of the other examples described above or below, wherein each converging time indicates an amount of time for the respective data point of the time-series to become converged to an acceptable convergence percentage.

An example as described alone or in combination with any of the other examples described above or below, wherein the one or more data sources comprise a telemetry system configured to monitor multiple client devices or servers.

An example as described alone or in combination with any of the other examples described above or below, wherein the processing further comprises applying one or more machine learning models to the retrieved data points of the time-series in order to detect one or more anomalies.

An example as described alone or in combination with any of the other examples described above or below, wherein the one or more real-time alerts correspond to detection of one or more anomalies.

An example as described alone or in combination with any of the other examples described above or below, wherein the time-series is associated with a communication application.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A real-time data monitoring system comprising:
a converging time-series generation component configured to:
analyze historical data of a time-series to determine converging times for data points of the time-series at various times of a day, each converging time indicating a predicted amount of time for the respective data point of the time-series to converge; and
generate a converging time-series that pairs the converging times with respective timestamps;
a data retrieval component configured to:
dynamically adjust a retrieval time for data points of the time-series based on the converging times of the converging time-series; and
retrieve each data point of the time-series at the determined retrieval time from one or more data sources;
the real-time data monitoring system configured to process the retrieved data points of the time-series to generate one or more real-time alerts.

2. The real-time data monitoring system of claim 1, wherein the data retrieval component is further configured to determine a converging time associated with a particular data point by matching a first timestamp associated with the particular data point in the time-series with a second timestamp associated with the converging time in the converging time-series.

3. The real-time data monitoring system of claim 2, wherein the data retrieval component is further configured to compute the retrieval time by adding the determined converging time to the first timestamp.

4. The real-time data monitoring system of claim 1, wherein each converging time indicates an amount of time for the respective data point of the time-series to become fully converged.

5. The real-time data monitoring system of claim 1, wherein each converging time indicates an amount of time for the respective data point of the time-series to become converged to an acceptable convergence percentage.

6. The real-time data monitoring system of claim 5, wherein the acceptable convergence percentage corresponds to a user-defined percentage.

7. The real-time data monitoring system of claim 1, wherein the one or more data sources comprise a telemetry system configured to monitor multiple client devices or servers.

8. The real-time data monitoring system of claim 1, wherein the real-time data monitoring system is configured to apply one or more machine learning models to the retrieved data points of the time-series in order to detect one or more anomalies.

9. The real-time data monitoring system of claim 8, wherein the one or more real-time alerts correspond to detection of one or more anomalies.

10. The real-time data monitoring system of claim 1, wherein the time-series is associated with a communication application.

11. The real-time data monitoring system of claim 1, wherein the converging time-series comprises a property of the time-series.

12. A computer-implemented method comprising:
in a real-time data monitoring system, analyzing historical data of a time-series to determine converging times for data points of the time-series at various times of a day, each converging time indicating a predicted amount of time for the respective data point of the time-series to converge;
generating a converging time-series that pairs the converging times with respective timestamps;
dynamically adjusting a retrieval time for data points of the time-series based on the converging times of the converging time-series;
retrieving each data point of the time-series at the determined retrieval time from one or more data sources; and
processing the retrieved data points of the time-series to generate one or more real-time alerts.

13. The computer-implemented method of claim 12, wherein the analyzing further comprises analyzing the historical data of the time-series to determine a converging time associated with a particular data point by matching a first timestamp associated with the particular data point in the time-series with a second timestamp associated with the converging time in the converging time-series.

14. The computer-implemented method of claim 13, further comprising computing the retrieval time by adding the determined converging time to the first time stamp.

15. The computer-implemented method of claim 12, wherein each converging time indicates an amount of time for the respective data point of the time-series to become fully converged.

16. The computer-implemented method of claim 12, wherein each converging time indicates an amount of time for the respective data point of the time-series to become converged to an acceptable convergence percentage.

17. The computer-implemented method of claim 12, wherein the one or more data sources comprise a telemetry system configured to monitor multiple client devices or servers.

18. The computer-implemented method of claim 12, wherein the processing further comprises applying one or more machine learning models to the retrieved data points of the time-series in order to detect one or more anomalies.

19. The computer-implemented method of claim 18, wherein the one or more real-time alerts correspond to detection of one or more anomalies.

20. The computer-implemented method of claim 12, wherein the time-series is associated with a communication application.
